(19) United States
(12) Patent Application Publication
(10) Pub. No.: US 2002/0110301 A1
(43) Pub. Date: Aug. 15, 2002

(54) Shell type roller bearing assembly

(75) Inventor: Masatoshi Niina, Iwata-shi (JP)

Correspondence Address: SUGHRUE, MION, ZINN, MACPEAK & SEAS, 2100 Pennsylvania Avenue, N.W., Washington, DC, 20037, US

(73) Assignee: NTN CORPORATION

(21) Appl. No.: 10/059,249

(22) Filed: Jan. 31, 2002

(30) Foreign Application Priority Data
Feb. 9, 2001 (JP) 2001-033537

(51) Int. Cl. F16C 33/58

(52) U.S. Cl. 384/569

(57) ABSTRACT

To provide a shell type roller bearing assembly with no crowing performed on rollers, effective to avoid an edge load and capable of being inexpensively manufactured, the bearing assembly includes a shell type outer race (1A) and a plurality of rollers (2) adapted to roll along a raceway (11). The outer race (1) being has a longitudinal sectional shape wherein a generally intermediate portion thereof has a wall thickness (h1) greater than that (h2) of each of the opposite ends thereof. This outer race (1A) when inserted into a mounting bore (14) in a housing (13) causes the raceway (11) to represent a substantially crowned shape.

### BACKGROUND OF THE INVENTION

1. Field of the Invention

The present invention relates to a shell type roller bearing assembly such as, for example, a journal roller bearing.

2. Description of the Prior Art

An exemplary one of the shell type roller bearing assemblies that is used as a journal roller bearing is shown in FIG. 11. As shown therein, the shell type roller bearing assembly includes an outer race 51 serving as a shell in the form of a press molded article of, for example, a steel plate. This outer race 51 has an inner peripheral surface defining an outer raceway 51a held in rolling contact with a plurality of circumferentially spaced rollers 52 retained by a roller retainer or cage 53 and intervening between the outer raceway 51a and an outer peripheral surface of a shaft 55 that defines an inner raceway.

The shell type outer race 51 hitherto formed by the use of a press molding technique is specifically designed with a view to use in press fitting into a highly precisely machined cylindrical mounting bore 54a that is defined in a housing 54, so as to provide a precision of the outer raceway 51a when the shell type outer race 51 is press fitted into such mounting bore 54a.

Each of the rollers 52 is, in order to avoid an edge load (a concentrated load) that may be induced at the interface between each roller 52 and the outer race 51, generally formed with a crowned portion of a slight radius of curvature at each of opposite ends thereof as shown in FIG. 12. The crowned portion 52a at the opposite ends of the roller 52 is generally formed by the use of a centerless grinding machine or a tumbler.

However, considering that the shell type bearing assembly makes use of a relatively large number of the rollers 52, formation of the above discussed crowned portions 52a in all of those rollers 52 involves a less productivity, resulting in increase of the cost of manufacture of the bearing assemblies.

Also, the shell generating line prior to the shell type outer race 51 beig press fitted into the mounting bore 54a generally exhibits such a tendency as shown in FIG. 13 with the outer diameter at each end thereof tending to increase. For this reason, the roller bearing assembly after having been press fitted tends to be loaded with a clamping force brought about by opposite collars 51b at respective ends of the outer race 51 and, therefore, an intermediate portion of the roller bearing assembly does not exhibit a stable shape. In the worst it may happen, a slight gap may be formed between a portion of the outer peripheral surface of the outer race 51 substantially intermediate of the length thereof and an inner surface of the housing 54 defining the mounting bore 54a. Instable shape of the intermediate portion of the roller bearing assembly may result in disturbance to a smooth rotation of the rollers 52. Although if the inner and outer peripheral surfaces of the outer race 51 are machined to a high precision, the shape of that portion of the roller bearing assembly may be stabilized even after the outer race 51 has been press fitted into the housing 54, this results in increase of the manufacturing steps and, in turn, increase of the manufacturing cost.

### SUMMARY OF THE INVENTION

Accordingly, the present invention is intended to attain a smooth rotation of a bearing assembly inexpensively and with no need to use a crowned process with respect to the rollers and also with no need to perform a precise machining with respect to the outer peripheral surface of the outer race.

In order to accomplish the foregoing object, the present invention in accordance with one aspect thereof provides a shell type roller bearing assembly which includes a shell type outer race of a cylindrical shape having an inner peripheral surface defining a raceway and also having a cylindrical wall, opposite ends confronting to each other in an axial direction and a portion generally intermediate between the opposite ends thereof, and a plurality of rollers adapted to roll along the raceway. The cylindrical wall of the outer race is of a longitudinal sectional shape, or a sectional shape viewed on a sectioning plane including an axis of the outer race, wherein the generally intermediate portion thereof has a wall thickness greater than that of each of the opposite ends thereof with an axially intermediate portion of the raceway representing a substantially radially inwardly crowned shape.

According to this structure, since the raceway of the outer race is crowned, the undesirable edge load can be avoided with no need for each of the rollers to have crowned opposite ends. Also, since the outer race is of a shape having the axially intermediate portion of a wall thickness greater than that of each of the opposite ends thereof, the crowned shape of the raceway can be retained even though the outer race is press fitted into the housing. Thus, since the outer race is of a design in which the raceway is crowned to eliminate the edge load, as compared with the rollers each having its opposite ends crowned, the smoothly rotatably bearing assembly can be manufactured inexpensively.

The present invention according to another aspect thereof also provides a shell type roller bearing assembly which includes a shell type outer race of a cylindrical shape having an inner peripheral surface defining a raceway and also having a cylindrical wall, opposite ends confronting to each other in an axial direction and a portion generally intermediate between the opposite ends thereof, and a plurality of rollers adapted to roll along the raceway. The cylindrical wall of the outer race used therein is of a longitudinal sectional shape wherein the generally intermediate portion thereof has a wall thickness greater than that of each of the opposite ends thereof and is radially outwardly bulged, said generally intermediate portion of the cylindrical wall being adapted to represent a substantially radially inwardly crowned shape when the outer race is inserted into a cylindrical mounting hole defined in a housing.

Even in this case, the undesirable edge load can be avoided with no need for each of the rollers to be crowned at the opposite ends thereof and the inexpensive shell type roller bearing can be obtained.

Although the outer race has no crowned shape before press fit into the mounting bore, but when the outer race is press fitted into the mounting bore the outer peripheral surface of the outer race can be deformed to conform to the wall defining the mounting bore, an effect which the bulged portion brings on the resultant crowned shape is such that the bulged portion of the outer peripheral surface of the outer race is substantially radially inwardly flattened with the bulged portion elastically deformed, to thereby provide a substantially smooth outer peripheral surface of the outer race. For this reason, the crowned shape can be stably imparted to the inner peripheral surface of the outer race even though the outer peripheral surface of the outer race is not highly precisely machined.

In the practice of the present invention, the outer race used in the shell type roller bearing assembly according to any one of the aspects of the present invention may have a surface to be ironed.

In the shell type roller bearing assembly, the outer race is generally formed by means of a deep drawing process. By performing the ironing after this deep drawing, it is possible for the intermediate portion of the outer race to have the wall thickness greater than that of each of the opposite ends thereof. Also, since the ironing process can be performed with a press machine similar to that used in the practice of the deep drawing, as compared with a machining process such as grinding, the cost of manufacture can be suppressed. Accordingly, it is possible to make the raceway of the outer race to have a crowned shape with low manufacturing cost. For this reason, while an undesirable edge load is avoided, and with no need for each of the rollers to be crowned at its opposite ends, the more inexpensive shell type roller bearing assembly can be obtained.

Where the surface to be drawn is provided in the outer race as discussed above, the surface to be drawn may be the raceway of the outer race.

The surface when drawn exhibits an improved surface roughness. Accordingly, if the raceway of the outer race along which the rollers roll is chosen to be the surface to be drawn, a smooth rotation of the bearing assembly can be attained.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a fragmentary longitudinal sectional view of a shell type roller bearing assembly according to one preferred embodiment of the present invention;

FIG. 2 is a fragmentary longitudinal sectional view showing only an outer race of the roller bearing assembly shown in FIG. 1;

FIG. 3 is comprised of FIGS. 3A to 3D which are explanatory diagrams showing the sequence of manufacture of the outer race, respectively;

FIG. 4 is a longitudinal sectional view showing the outer race together with a die assembly used to draw the outer race;

FIG. 5 is a fragmentary longitudinal sectional view of the shell type roller bearing assembly according to another preferred embodiment of the present invention;

FIG. 6 is a fragmentary longitudinal sectional view showing only the outer race of the roller bearing assembly shown in FIG. 5;

FIG. 7 is an explanatory diagram showing a result of analysis of the shape of a raceway of the outer race when the latter is fitted in a housing;

FIG. 8 is a set of explanatory diagrams showing the sequence of manufacture of the outer race used in the roller bearing assembly shown in FIG. 5;

FIG. 9 is a longitudinal sectional view showing the outer race together with a die assembly used to draw the outer race;

FIG. 10 is a set of explanatory diagrams of a portion of the die assembly encompassed within the circle X in FIG. 9, showing how the outer race is being molded;

FIG. 11 is a fragmentary longitudinal sectional view showing the conventional shell type roller bearing assembly;

FIG. 12 is a fragmentary side view of a longitudinal half of one of roller elements used in the conventional shell type roller bearing assembly of FIG. 11; and

FIG. 13 is an explanatory diagram showing a result of analysis of the shape of a generating line of an outer periphery of the outer race used in the conventional shell type roller bearing assembly of FIG. 11.

### DETAILED DESCRIPTION OF THE EMBODIMENTS

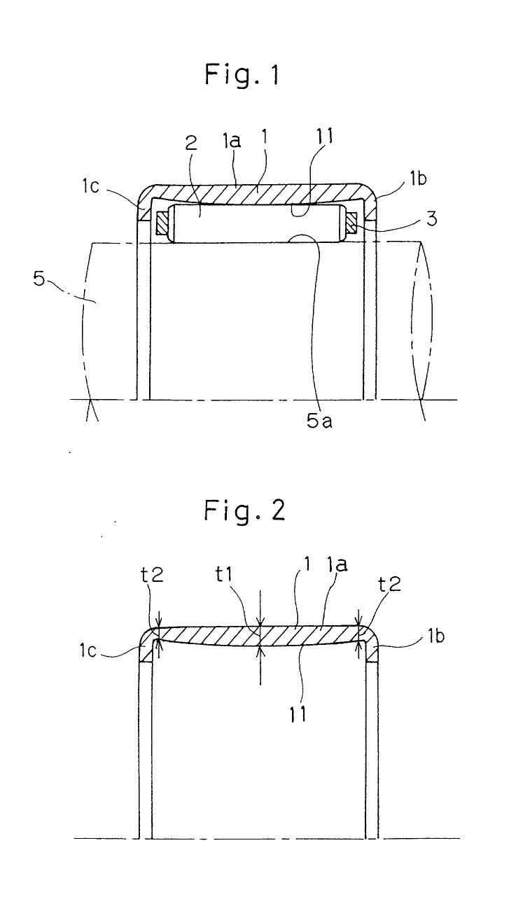

A first preferred embodiment of the present invention will be described with reference to FIGS. 1 to 4. A shell type roller bearing assembly shown in FIGS. 1 to 4 includes a shell type outer race 1 of a hollow cylindrical configuration having an inner peripheral surface defining an outer raceway 11, and a plurality of circumferentially spaced rollers 2 adapted to be held in rolling contact with the outer raceway 11. The outer race 1 has a cylindrical wall 1a having its opposite ends formed with radially inwardly extending respective collars 1b and 1c. The rollers 2 are retained by a ring-shaped roller retainer or cage 3 having a corresponding number of circumferentially spaced pockets defined therein for accommodating therein the respective rollers 2. The roller bearing assembly of the structure shown and described is used as a journal roller bearing and has no dedicated inner race and, instead, a portion of an outer peripheral surface of a shaft 5 encompassed by the roller bearing assembly defines an inner raceway 5a and, thus, that portion of the shaft 5 may be considered serving as the inner race positioned inside the outer race 1. It is to be noted that the rollers 2 are each in the form of a needle roller having its opposite ends chamfered, but having no crowned portion.

The cylindrical wall 1a of the outer race 1 is of a longitudinal sectional shape wherein a portion of the outer raceway 11 substantially intermediate of the length of the outer race 1 protrudes radially inwardly thereof to represents a generally crown shape, with a wall thickness t1 of a corresponding intermediate portion of the cylindrical wall being greater than the wall thickness t2 of each of the opposite ends thereof. It is, however, to be noted that an outer peripheral surface of the outer race 1 is of a cylindrical configuration. The ratio of the wall thickness t1 relative to the wall thickness t2, i.e., t1/t2, is preferably chosen to be within the range of 1.003 to 1.02.

It is also to be noted that the sectional shape of the cylindrical wall 1a of the outer race 1 discussed above applies when the outer race 1 is in a natural condition, that is, prior to the outer race being press fitted into a mounting bore (not shown) of the housing.

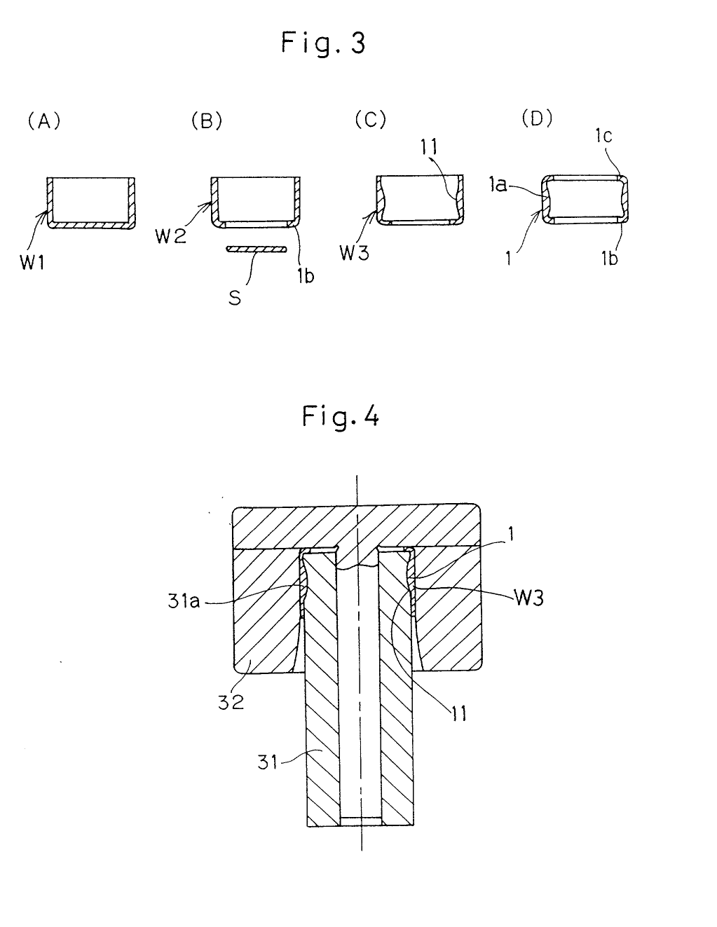

The outer race 1 is prepared from a metallic material such as, for example, a steel plate by the use of a press work. The outer race 1 so prepared is manufactured and shaped by the use of a plastic working process as shown in FIG. 3. At the outset, a metal sheet (not shown) is deep drawn to provide a generally cup shaped form WI as shown in (A) of FIG. 3, followed by a press work to blank a bottom S of the cup shaped form W1 to thereby provide a hollow cylindrical form W2 having a radially inwardly extending collar (corresponding to the collar 1b of the eventually formed outer race 1) at one end thereof as shown in (B) of FIG. 3. The cylindrical form W2 having the collar 1b is subsequently subjected to an ironing process to provide an intermediate product W3 wherein a portion of an inner peripheral surface (corresponding to the outer raceway 11) of a cylindrical body (corresponding to the cylindrical wall 1a) substantially intermediate of the length thereof protrudes radially inwardly thereof to represents a generally crowned shape with a wall thickness of that intermediate portion of the cylindrical wall being greater than that of each of the opposite ends thereof as shown (C) of in FIG. 3. Thereafter, a free end portion of the cylindrical body opposite to the collar is radially inwardly bent so as to protrude radially inwardly to provide the opposite collar (corresponding to the collar 1c of the eventually formed outer race 1) as shown in (D) of FIG. 3, thereby completing the outer race 1. Heat treatment of the outer race 1 is carried out, for example, after the deep drawing to provide the intermediate product W3 and prior to the free end portion of the cylindrical body being bent radially inwardly to provide what corresponds to the collar 1c of the resultant outer race 1.

The ironing process discussed above to form the crowned portion in the cylindrical wall is carried out by the use of a punch 31 having an annular shaping depression 31a that imparts a crowning to the cylindrical body of the intermediate product W3, and a die 32 for ironing an outer peripheral surface of the cylindrical body of the intermediate product W3 as shown in FIG. 4. In a condition as shown in FIG. 4, the material used to form the intermediate product W3 and, hence, the outer race fluidizes plastically into a space defined in the annular shaping depression 31a to eventually form the crowned portion in the outer raceway 11.

Thus, in the shell type roller bearing assembly of the structure described above, it will readily be seen that since the outer raceway 11 held in rolling contact with the rollers 2 is locally crowned and, accordingly, an undesirable edge load can be avoided with no need for each of the rollers 2 to be crowned at its opposite ends such as shown in FIG. 12. The crowned portion in the outer raceway 11 of the outer race 1 can be obtained by the utilization of the ironing process and particularly by the use of a press work in a manner similar to the deep drawing as shown in FIG. 3 and, therefore, the shell type roller bearing assembly can be advantageously mass-produced at a substantially reduced cost. Also, since the ironing process has been applied to the outer raceway 11, the outer raceway 11 can exhibit a satisfactory surface roughness enough to allow the rollers to roll smoothly in contact therewith.

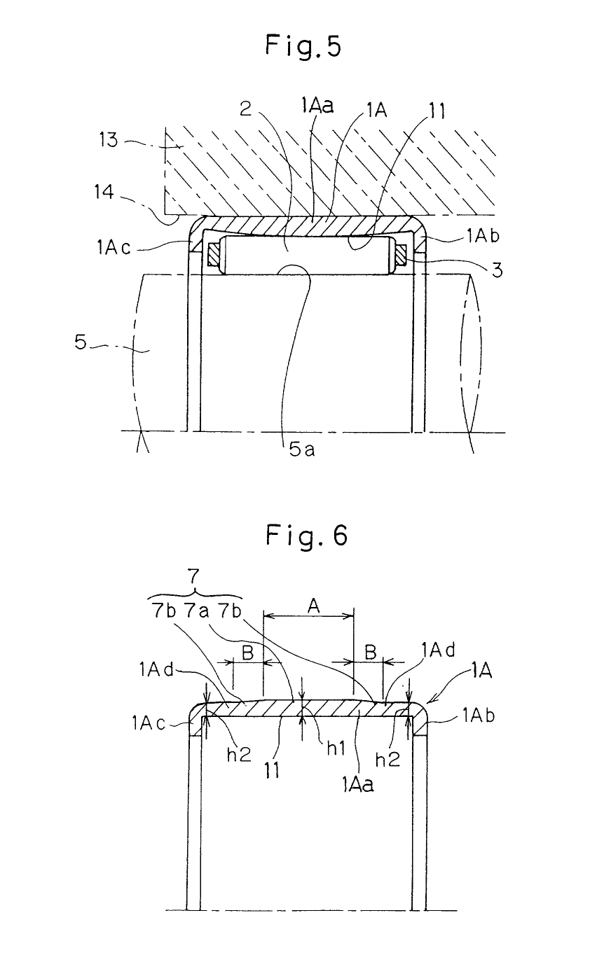

FIGS. 5 to 10 illustrates another preferred embodiment of the present invention. The shell type roller bearing assembly shown therein includes an outer race 1A having a cylindrical wall 1Aa representing a sectional shape wherein a portion of the cylindrical wall 1Aa substantially intermediate of the length of the outer race 1A protrudes radially outwardly thereof to have a bulged wall portion 7 of a wall thickness h1 that is greater than the wall thickness h2 of each of the opposite ends thereof. Preferably, the ratio of the wall thickness h1 relative to the wall thickness h2, i.e., h1/h2, is chosen to be within the range of 1.005 to 1.025. As is the case with the previously described embodiment, the outer race 1A is press fitted into a cylindrical mounting bore 14 defined in a housing 13. However, when the outer race 1A is so press fitted into the cylindrical mounting bore 14, a portion of an outer raceway 11 of the outer race 1A aligned with the bulged wall portion 7 is forced to deform radially inwardly in contact with a wall defining the mounting bore 14 to thereby represent a generally crowned shape as clearly shown in FIG. 5.

Other structural features of the shell type roller bearing assembly according to this second preferred embodiment are substantially identical with those according to the previously described first preferred embodiment. Specifically, the outer race 1A including the cylindrical wall 1Aa having its opposite ends formed with respective collars 1Ab and 1Ac, and each of the rollers 2 having no crowned end edge and being retained by the roller retainer 3 are all substantially identical with those in the embodiment shown in FIG. 1.

Specifically as shown in FIG. 6, the radially outwardly bulged wall portion 7 in the outer race 1A is specifically of a generally trapezoidal shape wherein an axially intermediate portion 7a of a width A represents a cylindrical outer surface area and portions 7b of a width B on respective sides of the intermediate portion 7a are inclined downwardly towards the adjacent ends of the outer race 1A. Preferably, the width A of the axially intermediate portion 7a is chosen to be within the range of ⅓ to ⅔ of the axial length of the outer race 1 and the width B of each portion 7b next to the axially intermediate portion 7a in a direction endwise of the outer race 1A is chosen to be equal to or smaller than half the width A of the axially intermediate portion 7a. Remaining portions of the outer race 1A adjacent the opposite ends of the outer race 1A and where no radially outwardly bulged wall portion is formed represent a cylindrical surface area.

The outer race 1A is prepared from a metallic material such as, for example, a steel plate by the use of a press work. The outer race 1A so prepared is manufactured and shaped by the use of a plastic working process as is the case with the outer race 1 used in the previously described embodiment. Specifically, at the outset, a metal sheet (not shown) is deep drawn to provide a generally cup shaped form WA1 as shown in (A) of FIG. 8, followed by a press work to blank a bottom S of the cup shaped form WA1 to thereby provide a hollow cylindrical form WA2 having a radially inwardly extending collar (corresponding to the collar 1Ab of the eventually formed outer race 1A) at one end thereof as shown in (B) of FIG. 8. The cylindrical form WA2 having the collar 1Ab is subsequently subjected to a drawing process to provide an intermediate product WA3 wherein a portion of a outer peripheral surface of a cylindrical body (corresponding to the cylindrical wall 1Aa) substantially intermediate of the length thereof protrudes radially outwardly thereof to define a radially outwardly bulged wall portion 7 of a generally trapazoidal shape with a wall thickness of that intermediate portion of the cylindrical wall being greater than that of each of the opposite ends thereof as shown in (C) of FIG. 8. Thereafter, a free end portion of the cylindrical body opposite to the collar 1Ab is radially inwardly bent so as to protrude radially inwardly to provide the opposite collar (corresponding to the collar 1Ac of the eventually formed outer race 1A) as shown in (D) of FIG. 8, thereby completing the outer race 1A. Heat treatment of the outer race 1A is carried out, for example, after the deep drawing to provide the intermediate product WA3 and prior to the free end portion of the cylindrical body being bent radially inwardly to provide what corresponds to the collar 1Ac of the resultant outer race 1A.

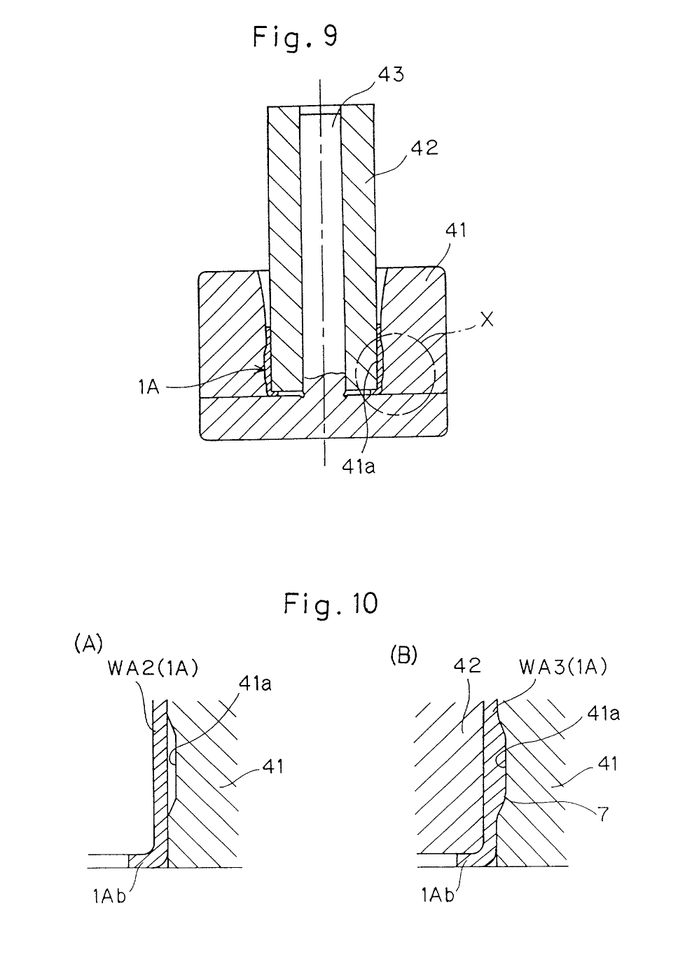

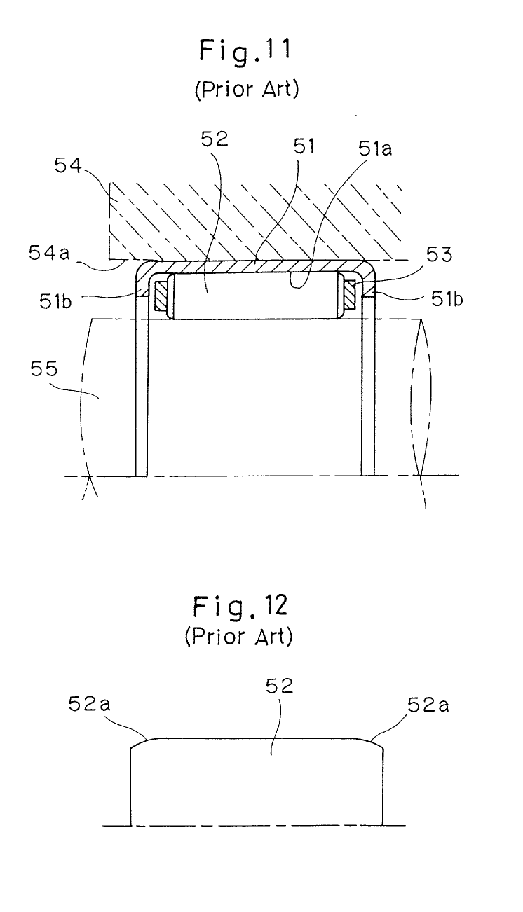

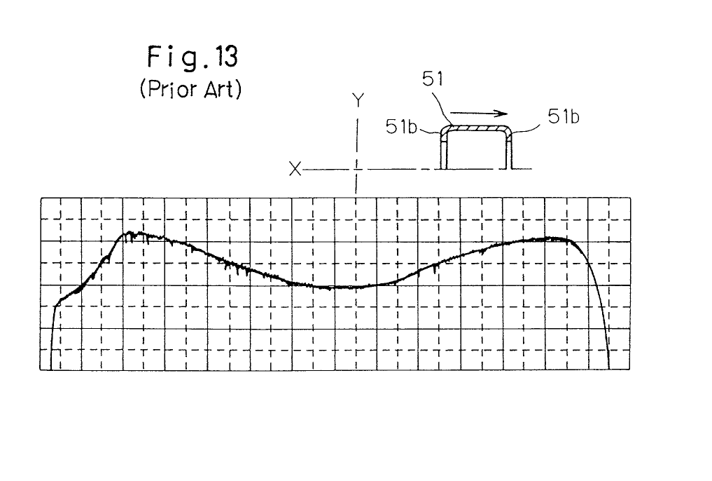

The ironing process discussed above to form the radially outwardly bulged wall portion 7 in the cylindrical wall 1Aa is carried out by the use of, for example, as shown in FIGS. 9 and 10, a die 41 having its inner peripheral surface depressed radially inwardly to define an annular shaping depression 41a that imparts a trapezoidal shape to that intermediate portion of the cylindrical body of the intermediate product W3, and a punch 42 for ironing an inner peripheral surface of the cylindrical body of the intermediate product W3. The die 41 includes a guide rod 43 engageable slidably into a center hole of the punch 42 for guiding up and down movement of the punch 42 relative to the die 41.

FIG. 10 illustrates a portion of the die assembly encompassed within the circle X shown in FIG. 9, showing how the outer race 1A is being ironed to form the radially outwardly bulged wall portion. When the punch 42 has not yet been inserted into the die 41, the annular shaping depression 41a is left vacant as shown in FIG. 10A. However, as the punch 42 is inserted under interference into the inner peripheral surface of the die 41 to apply ironing to the hollow cylindrical form WA2, the hollow cylindrical form WA2 is radially outwardly urged in contact with the punch 42 with a portion thereof progressively fluidizing plastically to fill up the annular shaping depression 41a to thereby complete the intermediate product WA3 having an axially intermediate portion thereof bulged radially radially outwardly which eventually defines the generally trapezoidal bulged wall portion 7 on the outer peripheral surface of the resultant outer race 1A.

It is to be noted that FIG. 8 showing the process of making the outer race 1A, as well as FIG. 3 similarly showing the process of making the outer race 1 in the previously described embodiment, merely illustrates an important methodological perspective of interest and, therefore, if so desired or required, one or more additional process steps may intervene between the successively occurring steps of the illustrated process. By way of example, the deep drawing step may be repeated in succession a desired number of times and/or the ironing process may be performed a desired number of times. Also, a shaping step for processing various local portions may be additionally employed.

The outer raceway 11a of the outer race 1A employed in the shell type roller bearing assembly according to the embodiment shown in FIGS. 5 to 10 does not represent a crowned shape so long as the outer race 1A has not yet been press fitted into the mounting bore 14 in the housing 13 as shown in FIG. 6. However, since the cylindrical wall 1Aa of the outer race 1A has the radially outwardly bulged wall portion of the wall thickness h1 that is greater than the wall thickness h2 of each of the opposite ends thereof, insertion of the outer race 1A under interference into the mounting bore 14 can result in the outer peripheral surface of the outer race 1A to conform to the shape of the mounting bore 14 while urging the bulged wall portion 7 to deform radially inwardly to thereby render the inner peripheral surface of the outer race 1A to represent the generally crowned shape as clearly shown in FIG. 5. Accordingly, an undesirable edge load can be avoided with no need for each of the rollers 2 to be crowned at its opposite ends such as shown in FIG. 12.

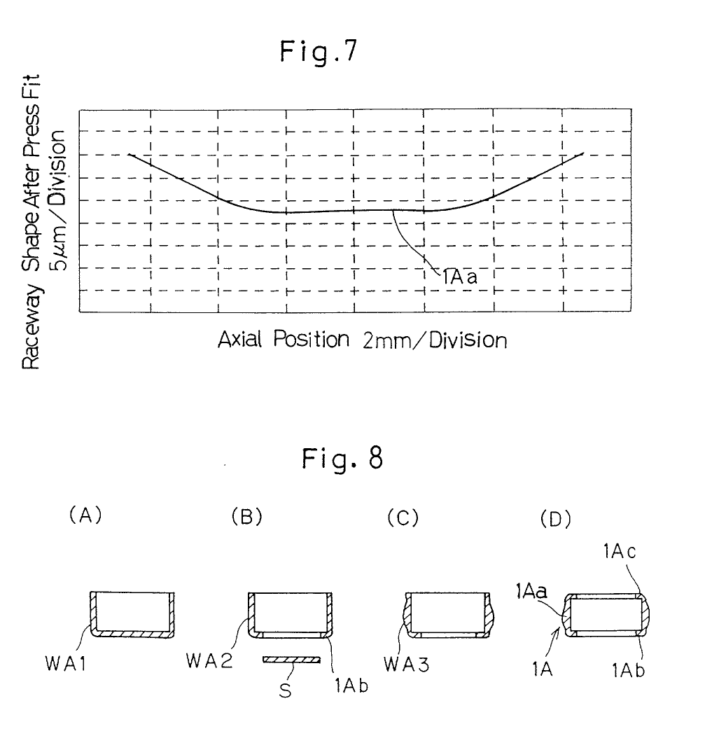

A result of analysis of the manner of deformation taking place when the outer race 1A is inserted under interference into the mounting bore 14 of the housing 13 is shown in FIG. 7. As shown in FIG. 7, the outer raceway 11a of the outer race 1A represents a generally crowned shape. It has also been confirmed that when the outer race 1A of the configuration shown in FIG. 6 was actually manufactured and was then press fitted into the mounting bore of a cylindrical shape, the outer raceway 11a of the outer race 1A so manufactured represented the shape matching with the result of analysis shown in FIG. 7.

As can readily be understood from the chart of FIG. 7, when the outer raceway 11a is imparted a crowned shape by providing the outer peripheral surface of the outer race 1A with the radially outwardly bulged portion 7 so that when the outer race 1A is press fitted into the mounting bore 14 the outer peripheral surface 1A of the outer race 1A can be deformed to conform to the wall defining the mounting bore 14, an effect which the bulged portion 7 brings on the resultant crowned shape is such that the bulged portion 7 of the outer peripheral surface of the outer race 1A is substantially radially inwardly flattened with the bulged portion 7 elastically deformed, to thereby provide a substantially smooth outer peripheral surface of the outer race 1A. For this reason, even though the bulged portion 7 represents the generally trapezoidal shape as viewed in the longitudinal sectional view of the outer race, the crowned shape with edges rounded can be obtained such as in the illustrated embodiment. Accordingly, even though the outer peripheral surface of the outer race 1A is not machined to a high precision, an ideal crowning can be imparted to the inner peripheral surface of the outer race 1A stably.

Thus, without the raceway 11a being directly machined in shape, the intended shape can be obtained merely by press fitting the outer race 1A into the mounting bore 14 and, therefore, with a simplified treatment with no highly precise machining required, the desirable crowning can be obtained in the outer race 1A. Moreover, since in the illustrated embodiment the outer race 1A has that axially intermediate portion of the wall thickness greater than that of each of the opposite ends thereof to provide the bulged portion 7, and unlike the case in which a crowning is formed while the wall thickness remains constant, there is no problem associated with formation of a gap between the outer peripheral surface of the outer race 1A and the mounting bore 14 at an axially intermediate area, which would otherwise result from when a fastening force locally acts on a portion of the outer peripheral surface aligned with each collar 1Ab and 1Ac from the wall defining the mounting bore even though the collars 1Ab and 1Ac are present at the opposite ends of the outer race 1A.

Also, although according to the illustrated embodiment, the wall thickness h1 of that intermediate portion of the outer race 1A is designed to be greater than the wall thickness h2 of the opposite ends thereof by subjecting the outer race 1A to the ironing process, the ironing process can be performed by the use of a press machine as is the case with the deep drawing process and, therefore, the raceway 11a of the outer race 1A can be rendered to represent the crowned shape with the cost being suppressed. Accordingly, the shell type roller bearing assembly can be manufactured inexpensively.

Moreover, according to the embodiment shown in and described with reference to FIGS. 5 to 10, the ironing process is applied to the raceway 11a and, therefore, the resultant raceway 11a can attain a satisfactory surface roughness, making it possible for the roller bearing assembly to rotate smoothly.

Although the present invention has been fully described in connection with the preferred embodiments thereof with reference to the accompanying drawings which are used only for the purpose of illustration, those skilled in the art will readily conceive numerous changes and modifications within the framework of obviousness upon the reading of the specification herein presented of the present invention. By way of example, although the present invention has been described as applied to the shell type journal roller bearing assembly wherein that portion of the outer peripheral surface of the shaft encompassed by such bearing assembly defines the inner raceway cooperable with the outer raceway defined in the outer race 1 or 1A, the present invention can be equally applied to any other shell type roller bearing of a type employing a separate inner race independent from the shaft.

Accordingly, such changes and modifications are, unless they depart from the scope of the present invention as delivered from the claims annexed hereto, to be construed as included therein.

What is claimed is:

1. A shell type roller bearing assembly which comprises:
a shell type outer race of a cylindrical shape having an inner peripheral surface defining a raceway, said outer race also having a cylindrical wall, opposite ends confronting to each other in an axial direction and a portion generally intermediate between the opposite ends thereof;
a plurality of rollers adapted to roll along the raceway;
said cylindrical wall of the outer race being of a longitudinal sectional shape wherein the generally intermediate portion thereof has a wall thickness greater than that of each of the opposite ends thereof with an axially intermediate portion of the raceway representing a substantially crowned shape.

2. The shell type roller bearing assembly which comprises:
a shell type outer race of a cylindrical shape having an inner peripheral surface defining a raceway, said outer race also having a cylindrical wall, opposite ends confronting to each other in an axial direction and a portion generally intermediate between the opposite ends thereof;
a plurality of rollers adapted to roll along the raceway;
said cylindrical wall of the outer race being of a longitudinal sectional shape wherein the generally intermediate portion thereof has a wall thickness greater than that of each of the opposite ends thereof and is radially outwardly bulged, said generally intermediate portion of the cylindrical wall being adapted to represent a substantially radially inwardly crowned shape when the outer race is inserted into a cylindrical mounting hole defined in a housing.

3. The shell type roller bearing assembly as claimed in claim 1, wherein the outer race has a surface to be ironed.

4. The shell type roller bearing assembly as claimed in claim 2, wherein the outer race has a surface to be ironed.

5. The shell type roller bearing assembly as claimed in claim 3, wherein the surface to be ironed is the raceway of the outer race.

6. The shell type roller bearing assembly as claimed in claim 4, wherein the surface to be ironed is the raceway of the outer race.

7. The shell type roller bearing assembly as claimed in claim 2, wherein the cylindrical wall representing the crowned shape has a radially outwardly bulged portion, said bulged portion of the cylindrical wall representing a generally trapezoidal longitudinal sectional shape.
